(19) United States
(12) Patent Application Publication
(10) Pub. No.: US 2021/0009817 A1
(43) Pub. Date: Jan. 14, 2021

(54) DEHYDRATED COATING COMPOSITIONS IN SOLID FORM, PRODUCTION METHOD THEREOF, AND METHOD FOR REHYDRATING SAME

(71) Applicant: NOF METAL COATINGS EUROPE, Creil (FR)

(72) Inventors: Jean-Marie POULET, Senlis (FR); Didier LABOUCHE, Saint Amand les Eaux (FR); Stéphanie BRUYERE, Villers Sous Saint-Leu (FR)

(21) Appl. No.: 16/766,800

(22) PCT Filed: Nov. 28, 2018
(86) PCT No.: PCT/EP2018/082889

§ 371 Date: May 26, 2020

(30) Foreign Application Priority Data
Nov. 28, 2017 (FR) 1761264

(51) Int. Cl. C09D 5/10; B05D 3/00; C08K 13/04; C08K 3/08; C08K 5/5415; C08K 9/08

(52) U.S. Cl. CPC C09D 5/10; B05D 3/002; C08K 13/04; B05D 3/0254; C08K 5/5415; C08K 9/08; C08K 3/08

(57) ABSTRACT

The present invention relates to a water-rehydratable solid composition for the production of an aqueous composition comprising a particular metal, a silane/(titanate and/or zirconate) binder, a method for producing such a composition, and a method for producing an aqueous composition comprising a particular metal, a silane/(titanate and/or zirconate) binder by hydrating such a solid composition.

The invention concerns dehydrated coating compositions in solid form, a process for obtaining them and their rehydration for the preparation of an aqueous coating composition, in particular for protecting metal parts from corrosion.

Anti-corrosion coating compositions for metal parts based on particulate metal in aqueous dispersion comprising a titanate- and/or zirconate-based and silane-based binder, and water (WO2005/078026) are known.

The invention now provides dehydrated coating compositions which, in particular, reduce the storage volume and increase the life of the coating compositions.

The invention has as its first subject matter a water-hydratable solid composition intended for the preparation of an anti-corrosion coating composition for metal parts based on particulate metal in aqueous dispersion, said solid composition being based on a particulate metal or a mixture of particulate metals, a titanate precursor and/or a zirconate precursor and a silane bearing at least one function hydrolyzable to a hydroxyl function with a Ti/Si molar ratio ranging from 10/90 to 60/40.

The titanate, zirconate, silane, and optionally a silicate, together form a binder.

Surprisingly, it has been found that one of the essential conditions for rehydration of the solid composition is that it is based on a titanate Ti precursor and/or a zirconate Zr precursor. Advantageously, the solid composition is based on a titanate Ti precursor.

For the purposes of the present invention, “precursor” means a chemical reagent which initiates a reaction. It is often an alkoxide (alkoxide of the formula M(OR)n: where M is a metal, for example Ti, Zr or Si, and R is an organic alkyl group CnHn-1) or a metal salt.

For the purposes of the present invention, “titanate precursor” means a compound comprising at least one titanium atom and capable of forming covalent bonds between themselves or with the other precursors, including the silicon precursors silane and silicate, to form a binder.

For the purposes of the present invention, “zirconate precursor” means a compound comprising at least one zirconium atom and capable of forming covalent bonds between themselves or with the other precursors, including the silicon precursors silane and silicate, to form a binder.

For the purposes of the present invention, “silane” means an organic compound comprising at least one Si atom with at least one Si—C bond. In a silane, the bonds to the silicon atom, in addition to the Si—C bond, are generally Si—O, Si—Si or Si—H bonds, more advantageously Si—O.

For the purposes of the present invention, “silicate” means an organic or inorganic compound, advantageously organic, comprising at least one Si atom without Si—C bonds. In a silicate, the bonds with the silicon atom are generally Si—O, Si—Si or Si—H bonds, more advantageously Si—O.

For the purposes of the present invention, “particle size” means the maximum dimension of the particle under consideration.

For the purposes of the present invention, “composition based on” means a composition comprising the mixture and/or the product of in situ reaction of the various basic constituents used, some of these constituents being capable of reacting and/or being intended to react with each other, at least partially, during the various phases of preparation of the composition, or during subsequent baking, modifying the composition as it is prepared at the outset. Thus, the compositions as used for the invention may be different in the non-cross-linked state and in the cross-linked state.

For the purposes of the present invention, “solid composition” means a composition in the form of a hard gel or in powder form. The solid composition is advantageously obtained by dehydration of an aqueous composition. The solid composition is rehydratable with water and is intended for the preparation of an anti-corrosion coating composition for metal parts based on particulate metal in aqueous dispersion.

For the purposes of the present invention, “aqueous composition” means an aqueous composition based on a particulate metal or a mixture of particulate metals, a titanate precursor and/or a zirconate precursor and a silane bearing at least one function hydrolyzable to a hydroxyl function according to the invention, which is intended to be dehydrated to give the solid composition according to the invention.

For the purposes of the present invention, “coating composition” means a composition based on particulate metal in aqueous dispersion, intended to be applied to a substrate, in particular a metallic substrate, and then subjected to a baking operation in order to produce the coating. The coating composition consists of the rehydrated solid composition and optionally other compounds added to this composition. In this application, the term “aqueous coating composition” may also be used.

For the purposes of the present invention, the “coating” is thus obtained by applying the coating composition to a substrate, in particular a metallic substrate, the coating layer then being subjected to a baking operation. The terms “coating”, “anti-corrosion coating” and “dry coating film” are used synonymously in this application.

For the purposes of the present invention, “dry matter content” means the content of the residue obtained by evaporation of the solvents and volatile matter contained in the initial aqueous composition or the initial coating composition; evaporation being advantageously carried out in an oven for 1 h at 180° C. The dry matter content is expressed as a percentage by weight based on the total weight of the initial aqueous composition or initial coating composition.

The molar ratio (Ti+Zr)/Si varies advantageously from 10/90 to 60/40, more advantageously from 20/80 to 50/50, even more advantageously from 25/75 to 50/50.

The source of silicon is silane, but can also be partly silicate. When a silicate is also present, the silane is nevertheless predominant in terms of moles.

The source of Ti is advantageously an organic titanate. The source of Zr is advantageously an organic zirconate.

When the composition does not include zirconate, the Ti/Si molar ratio varies advantageously from 10/90 to 60/40, more advantageously from 20/80 to 50/50, even more advantageously from 25/75 to 50/50.

The solid composition is advantageously in gel or powder form, with particle sizes ranging from about 2 μm to about 3 mm.

The titanate precursor is advantageously an organic titanate.

In a first, preferred embodiment, the organic titanate is selected from C₁-C₁₀ tetraalkyl titanates, advantageously C₁-C₈ tetraalkyl titanates. They can be represented by the following formula (I):

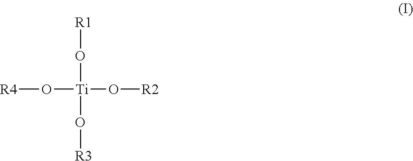

wherein R1, R2, R3 and R4 independently represent an optionally substituted C₁-C₁₀, preferably C₁-C₈, alkyl radical. The C₁-C₁₀ tetraalkyl titanate advantageously C₁-C₈ tetraalkyl titanate is advantageously selected from the group consisting of tetraethyl titanate (TET, Ti(OC₂H₅)₄), tetra-n-butyltitanate (TₙBT, Ti(OC₄H₉)₄, tetra-isopropoxytitanate (Ti(OCH(CH₃)₂)₄), tetra-n-propoxytitanate (Ti(OCH₂CH₂CH₃)₄) and octylene glycoltitanate (OGT, TI(O₂C₈H₁₇)₄).

In a second embodiment, the organic titanate is selected from organic titanates in chelate form that are not compatible with water (compatible in the organic phase), in particular titanium acetylacetonate and diisopropoxy-bisethylacetoacetato titanate, marketed by Dorf Ketal under the names TYZOR® AA (titanium acetylacetonate), and TYZOR® DC (diisopropoxy-bisethylacetoacetato titanate).

In a third embodiment, the organic titanate is selected from among the chelated titanates compatible in aqueous phase, which can advantageously be represented by the following general formula (II):

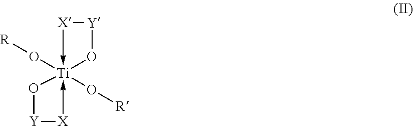

wherein R and R′ independently represent an optionally substituted C₁-C₁₀, advantageously C₁-C₈, alkyl radical, X and X′ independently represent a functional group comprising an oxygen or nitrogen atom, and Y and Y′ independently represent a hydrocarbon chain having 1 to 4 carbon atoms. X and X′ advantageously represent an amino or lactate radical.

The organic titanate in chelate form compatible in aqueous phase is advantageously selected from the group consisting of triethanolamine titanates (TYZOR© TE and TEP marketed by Dorf Ketal). As an example of organic titanates in chelate form compatible in aqueous phase, mention may also be made of alkanolamine titanate in chelate form and titanate-lactic acid chelate, marketed by Dorf Ketal under the names TYZOR® TA (alkanolamine titanate in chelate form) and TYZOR® LA (titanate-lactic acid chelate).

The zirconate precursor is advantageously an organic zirconate.

In a first, preferred embodiment, the organic zirconate is selected from C₁-C₁₀ tetraalkyl zirconates, advantageously C₁-C₈ tetraalkyl zirconates, which can advantageously be represented by the following formula (III):

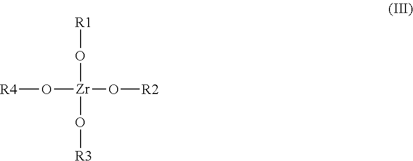

wherein R1, R2, R3 and R4 independently represent an optionally substituted C₁-C₁₀, preferably C₁-C₈, alkyl radical. The tetra-C₁-C₁₀-alkyl zirconate, advantageously tetra-C₁-C₈-alkyl zirconate, is advantageously selected from the group consisting of tetra-n-propyl zirconate and tetra-n-butyl zirconate.

In a second embodiment, the organic zirconate is selected from organic zirconates in chelate form that are not compatible with water (compatible in the organic phase), in particular diethyl zirconate chelate marketed by Dorf Ketal under the name TYZOR® ZEC.

In a third embodiment, the organic zirconate is selected from the zirconate chelates compatible in aqueous phase, which can advantageously be represented by the following general formula (IV):

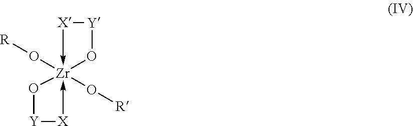

wherein R and R′ independently represent an optionally substituted C₁-C₁₀, preferably C₁-C₈, alkyl radical, X and X′ independently represent a functional group comprising an oxygen or nitrogen atom, and Y and Y′ independently represent a hydrocarbon chain having 1 to 4 carbon atoms. X and X′ advantageously represent an amino radical.

The organic zirconate chelate can advantageously be triethanolamine zirconate (TYZOR® TEAZ marketed by Dorf Ketal). Another example of organic zirconate in chelate form compatible in aqueous phase is the zirconate-lactic acid chelate marketed by Dorf Ketal under the name TYZOR® LAZ.

The titanate precursor is advantageously an organic titanate, more advantageously selected from C₁-C₈ tetraalkyl titanates, and the zirconate precursor is advantageously an organic zirconate, more advantageously selected from C₁-C₈ tetraalkyl zirconates.

The silane carries at least one function hydrolyzable to a hydroxyl function, advantageously selected from a C₁-C₄, preferably C₁-C₂, alkoxy radical.

The expression “function hydrolyzable to a hydroxyl function” means any chemical function that can react with water to become a hydroxyl-OH function.

The silane advantageously carries three, preferably identical, functions hydrolyzable to hydroxyl functions.

The silane carries at least one, advantageously one, hydrocarbon radical, connected to the silicon atom by one of its carbon atoms. This hydrocarbon radical may also include heteroatoms or halogens, advantageously heteroatoms. This hydrocarbon radical can be linear, branched or even comprise a ring. This hydrocarbon radical can advantageously comprise up to 10 carbon atoms, more advantageously from 4 to 10 carbon atoms.

In a preferred variant, the silane also carries an epoxy function (oxirane), which promotes cross-linking and adhesion to the substrate. Thus, the hydrocarbon radical advantageously contains an epoxy function.

The silane is advantageously easily dispersed in the aqueous medium and is preferably soluble in such a medium.

The silane used is advantageously an epoxy-functional silane selected from epoxy-functional di- or trimethoxysilane and epoxy-functional di- or triethoxysilane and mixtures thereof, in particular as beta-(3,4-epoxycyclohexyl)ethyltrimethoxysilane, 4-(trimethoxysilyl)butane-1,2-epoxide or gamma-glycidoxypropyltrimethoxysilane or gamma-glycidoxypropyltriethoxysilane. The silane used may also advantageously be octyltriethoxysilane, phenyltriethoxysilane, methyltriethoxysilane, (2-diethylphosphatoethyl) triethoxy silane, vinyltriethoxysilane, 3-Aminopropyltriethoxysilane, methylmethacrylate trimethoxysilane, or methylmethacrylate triethoxysilane.

The solid composition may also include a silicate. This silicate is also a source of Si. The silicate is advantageously an alkoxide of silicon, in particular tetraethyl orthosilicate (Si(OC₂H₅)₄ and called TEOS).

The particulate metal of the coating composition may be selected from the group consisting of metallic pigments such as aluminum, manganese, nickel, titanium, stainless steel, zinc, their alloys and mixtures thereof. The particulate metal is advantageously selected from zinc and aluminum and their alloys and mixtures thereof or their alloys with manganese, magnesium, tin or Galfan. The particulate metal present in the composition is advantageously in powder form, of various homogeneous or heterogeneous geometric structures, including spherical, lamellar, lenticular or other specific shapes. The particulate metal advantageously has a particle size between 0 and 100 μm not inclusive, and even more advantageously between 0 and 40 μm not inclusive.

Where the particulate metal is an alloy or mixture of zinc and aluminum, aluminum may be present in very small amounts, for example 1 to 5% by weight of the particulate metal, but still provide a shiny coating. Usually aluminum is at least 5% by weight of the particulate metal, so the weight ratio of aluminum to zinc is of the order of 0.5:9.5. On the other hand, for reasons of economy, aluminum accounts for no more than about 50% by weight of zinc and total aluminum, so the weight ratio of aluminum to zinc can be as high as 1:1. The particulate metal content in the solid composition will be such that in fine the particulate metal content of the coating composition will be greater than 0% and will not exceed about 80% by weight of the total weight of the coating composition to maintain the best coating appearance and will usually be at least 10% by weight to obtain a shiny coating.

The solid composition advantageously comprises more than 0% to 80% by weight, in particular 35% to 70%, more particularly 45% to 70% by weight, based on the total weight of the solid composition, of said particulate metal.

In an embodiment, the coating advantageously comprises from 0 to 80% by weight, more advantageously from 10 to 75% by weight, based on the total weight of the coating, of said particulate metal.

The solid composition according to the invention is advantageously obtained by dehydration of an aqueous composition into which said particulate metal, said titanate and/or zirconate precursor, said silane, optionally said silicate, and water have been introduced.

The aqueous composition is advantageously based on 5 to 25% by weight, more advantageously 7 to 20% by weight, even more advantageously 7 to 17% by weight, based on the total weight of the aqueous composition, of said silane. This amount corresponds to the amount of said silane introduced during the preparation of the aqueous composition. Once all the compounds of the aqueous composition have been introduced, they can/will react with each other to form new compounds, we will then speak in amount of Si elements.

Thus, in the solid composition according to the invention, the content of Si elements (atomic mass=28 g/mol) is advantageously between 0 (not included) and 5%, advantageously between 1 and 4%, more advantageously between 1 and 3%, by weight based on the total weight of the solid composition.

The aqueous composition is advantageously based on 0 to 5% by weight, more advantageously 0 to 1.5%, even more advantageously 0 to 1% by weight, based on the total weight of the aqueous composition, of said silicate. This amount also corresponds to the amount of said silicate introduced during the preparation of the aqueous composition.

The aqueous composition is advantageously based on 1 to 20% by weight, more advantageously 3 to 10% by weight, based on the total weight of the aqueous composition, of said titanate precursor, of said zirconate precursor or of mixtures thereof.

The aqueous composition is advantageously based on 1 to 20% by weight, more advantageously 3 to 10% by weight, based on the total weight of the aqueous composition, of said titanate precursor. In this variant, advantageously the aqueous composition does not include a zirconate precursor.

These amounts correspond to the amounts introduced of said titanate precursor, of said zirconate precursor or of mixture thereof during the preparation of the aqueous composition. Once all the compounds of the aqueous composition have been introduced, they can/will react with each other to form new compounds, we will then speak in amount of Ti elements and/or Zr elements.

Thus, in the solid composition according to the invention, the content of Ti elements (atomic mass=48 g/mol) and/or of Zr elements (atomic mass=91 g/mol) is advantageously between 0 (not included) and 10%, advantageously between 1.5 and 6% by weight based on the total weight of the solid composition. In an advantageous variant, the solid composition does not comprise a zirconate precursor and the content of Ti elements (atomic mass=48 g/mol) is advantageously between 0 (not included) and 5%, advantageously between 1.5 and 3% by weight based on the total weight of the solid composition.

The particulate metal may contain a minor amount of one or more solvents, for example dipropylene glycol and/or white spirit, especially when the metal has been prepared in lamellar form. Solvent-containing particulate metals are usually used in the form of pastes, which may be used directly with other ingredients in the composition. However, particulate metals may also be used in a dry form in the aqueous composition to be dehydrated.

Dehydration can be carried out by any means known to the person skilled in the art such as freeze-drying, zeodration, spray drying, or evaporation, including vacuum evaporation. Advantageously the solid composition is obtained according to the process described below.

For the purposes of the present invention, “aqueous composition” means a composition comprising, as the majority solvent, by weight, water or a water/alcohol mixture. Thus, the terms “aqueous composition” also include hydroalcoholic compositions. By “alcohol” is meant here any light alcohol, i.e. having less than 10 carbon atoms, and miscible with water, such as methanol, ethanol, isopropanol, n-propanol, butanol, octylene glycol.

In the present invention, said aqueous composition advantageously comprises at least 15% by weight, based on the total weight of said aqueous composition, of water, more advantageously at least 25% by weight of water, still more advantageously at least 30% by weight of water. In the case where the aqueous composition has as majority solvent a water/alcohol mixture, said aqueous composition advantageously comprises at least 20% by weight, based on the total weight of said aqueous composition, of the water/alcohol mixture, more advantageously at least 30% by weight of the water/alcohol mixture, still more advantageously at least 35% by weight of the water/alcohol mixture, still more advantageously at least 40% by weight of the water/alcohol mixture.

It was found that the solid composition was subsequently more easily rehydratable when the initial aqueous composition also included a heavy organic solvent, an ionic liquid, or mixtures thereof.

Thus, in an advantageous embodiment of the invention, the solid composition is obtained by dehydration of the aqueous composition described above, further comprising a heavy organic solvent, an ionic solvent, or mixtures thereof. In particular, by dehydration of said aqueous composition comprising from 0.5 to 15% by weight, advantageously from 0.5 to 11% by weight, based on the total weight of said aqueous composition, of heavy organic solvent, ionic liquid, or mixtures thereof. “Heavy organic solvent” in the context of the present invention means a water-miscible organic solvent whose vapor pressure at 20° C. is preferably less than 4 mmHg, advantageously less than 2 mmHg.

Particular examples of heavy organic solvents that can be used include glycol solvents such as glycol ethers, in particular diethylene glycol, triethylene glycol and dipropylene glycol, acetates, propylene glycol, polypropylene glycol, alcohols, ketones, propylene glycol methyl ether, 2,2,4 trimethyl pentanediol (1,3) isobutyrate (Texanol), white spirit and mixtures thereof.

Dipropylene glycol is particularly advantageous, in particular for economic and environmental reasons.

As a heavy organic solvent, esters such as ethyl lactate, methyl oleate or methyl or ethyl fatty acid esters can also be used.

Ionic liquids are salts having a melting temperature below 100° C., as described in the work “Electrodeposition from Ionic Liquids” edited by Frank Endres, Douglas MacFarlane, and Andrew Abbott and, in the context of the present invention, below room temperature. The cations are generally of the dialkylimidazolium, tetraalkylammonium, tetraalkylphosphonium or alkylpyridium type. The anions are generally of the tetrafluoroborate, hexafluorophosphate, halide, mesylate, tosylate, triflate or acetate type.

The solid composition according to the invention can then be rehydrated, without difficulty, to give an aqueous composition comprising a particulate metal, a binder based on silane and titanate and/or zirconate.

Surprisingly, it was found that a solid composition based on a silicon precursor and a titanate and/or zirconium precursor could easily be rehydrated whereas a solid composition based only on a silicon precursor could not be rehydrated.

Rehydration is conducted by adding water, advantageously under stirring. In addition to water, an organic solvent or an ionic liquid may also be added, in mass proportions corresponding to those described above for the initial aqueous composition, advantageously in an amount less than or equal to 15% by weight, advantageously less than or equal to 11% by weight, thus ranging from 0% to 15% by weight, advantageously from 0% to 11% by weight, based on the total weight of the water+(heavy organic solvent, ionic liquid and mixtures thereof) mixture. The amount of water, and optionally heavy organic solvent or ionic liquid, added generally corresponds to the amount of liquid that was present in the initial aqueous composition, in order to achieve the same dry matter content. In another embodiment, the amount of water, and optionally of heavy organic solvent or ionic liquid, added may be higher than the amount of liquid which was present in the initial aqueous composition to increase stability after rehydration. Thus, the initial aqueous composition can be more concentrated to increase productivity during dehydration and be rehydrated to a lower dry matter content to obtain a good stability of the final composition. The dry matter content of the targeted rehydrated composition varies advantageously from 35% to 50%, more advantageously from 38% to 45%. The dry matter content of the initial aqueous composition varies advantageously from 35% to 60%, more advantageously from 35% to 50%, even more advantageously from 38% to 45%.

The rehydrated aqueous composition is stable, at least as stable as the original aqueous composition, if not more stable.

According to an advantageous variant, one or more corrosion-inhibiting pigments is added to the solid composition, before or after dehydration, such as aluminum tri- or polyphosphate, phosphates, molybdates, alkali or alkaline earth silicates such as sodium, potassium or lithium silicate, and zinc, strontium, calcium, barium borates and mixtures thereof, in contents such that, when rehydrated, the composition comprises from 0.2 to 7% by weight, advantageously 0.2 to 4% by weight, of said pigment, based on the total weight of the rehydrated solid composition.

According to an advantageous variant, a wetting agent is added to the solid composition, before or after dehydration, in such a content that, once rehydrated, the composition advantageously comprises less than 4% by weight, advantageously between 0.1 and 4% by weight, of said wetting agent based on the total weight of the composition.

According to an advantageous variant, a pH modifier is added to the solid composition, before or after dehydration, generally selected from the oxides and hydroxides of alkali metals, advantageously lithium and sodium, the oxides and hydroxides of metals belonging to groups IIA and IIB of the periodic table, such as strontium, calcium, barium, magnesium and zinc compounds. The pH modifier may also be a carbonate or nitrate of the above-mentioned metals.

According to an advantageous variant, phosphates, phosphorus-containing substituents, such as ferrophosphate (pigment), inorganic salts, are added to the solid composition, before or after dehydration, in such a content that, once rehydrated, the composition comprises advantageously less than 5%, advantageously less than 2%, by weight relative to the weight of the rehydrated solid composition.

The composition according to the invention is advantageously free of chromium VI. The composition may, however, contain chromium in a soluble or insoluble form such as, for example, metallic chromium or chromium in oxidation state III.

The present invention also has as its subject matter a process for preparing a solid composition according to the invention, comprising a step of dehydration of an aqueous composition based on said particulate metal, said titanate and/or zirconate precursor, said silane, optionally said silicate, and water, as previously defined.

In a first embodiment, dehydration is carried out by freeze-drying.

Freeze-drying is a particularly well-known method for the low-temperature vacuum drying of previously frozen liquid products. Freeze-drying consists of the gradual removal of water from the previously frozen product by sublimation.

In this first embodiment, the process comprises a step of freezing said aqueous composition and then a step of freeze-drying.

Said aqueous composition can for example be frozen by the use of liquid nitrogen.

Freeze-drying is advantageously carried out at a temperature between −70° C. and −90° C., advantageously −80° C., and at a pressure between 0.05 mbar and 0.3 mbar, advantageously between 0.1 mbar and 0.26 mbar.

In a second embodiment, dehydration is carried out by zeodration.

The zeodration process is a vacuum drying method in the presence of a zeolite bed. It does not require a freezing step.

In a third embodiment, dehydration is carried out by vacuum evaporation, advantageously at a temperature close to room temperature.

The vacuum evaporation process is a well-known method of evaporating water at a temperature significantly lower than the standard boiling temperature.

In the present invention, vacuum evaporation is advantageously carried out at a temperature below 60° C., more advantageously from 35° C. to 50° C. The vacuum can be obtained for example with a pressure ranging from 15 mbar to 90 mbar. In particular, on a laboratory scale, for example, vacuum can be obtained with a pressure of 15 to 25 mbar, in particular 20 mbar; whereas on an industrial scale, for example, vacuum can be obtained with a pressure of 30 to 85 mbar, in particular between 50 and 80 mbar.

Alternatively, dehydration can be achieved by spray drying. Spray drying is a method of dehydrating a liquid in powder form by passing it through a stream of hot air. Advantageously, in the context of the present invention, the spray drying parameters are determined to obtain a powder temperature lower than 60° C., more advantageously ranging from 35° C. to 50° C.

Once the solid composition is obtained, by dehydration by a suitable method, in particular one of the four methods described above, the process may include a step of reducing the size of the powder particles, for example by means of a mechanical action which does not affect the integrity of the metal particles. This possible mechanical action applied to the solid particles obtained can be used to adjust the fineness of the desired powder. This step will affect the bulk density of the powder obtained and may accelerate the subsequent rehydration step.

According to another embodiment, once the solid composition is obtained, by dehydration according to a suitable method, in particular by spray drying, the process may include a granulation step to increase the size of the powder particles. This step will also affect the apparent density of the powder obtained and may accelerate the subsequent rehydration step.

The preparation of a solid composition, easily rehydratable, makes it possible in particular to reduce storage volumes. It also makes it possible to increase the service life of the coating composition since the solid composition is substantially less sensitive to degradation than an aqueous composition and that, after hydration, the aqueous composition obtained is at least as stable as the aqueous composition which has not been subjected to the process according to the invention.

The invention also relates to a process for preparing an aqueous composition comprising at least one particulate metal, a binder based on silane and titanate and/or zirconate comprising a step of hydration of a solid composition according to the invention or obtained by the process according to the invention.

Hydration, more precisely rehydration, is conducted by adding water, advantageously under stirring. In addition to water, an organic solvent or an ionic liquid may also be added, in mass proportions corresponding to those described above for the initial aqueous composition, advantageously in an amount less than or equal to 15% by weight, advantageously less than or equal to 11% by weight, thus ranging from 0% to 15% by weight, advantageously from 0% to 11% by weight, based on the total weight of the water+(organic solvent, ionic liquid and mixtures thereof) mixture. The amount of water, and optionally organic solvent or ionic liquid, added generally corresponds to the amount of liquid that was present in the initial aqueous composition, in order to achieve the same dry matter content. According to another embodiment of the invention, the initial aqueous composition may be more concentrated to increase productivity during dehydration and be rehydrated to a lower dry matter to obtain a good stability of the final composition.

The targeted dry matter content varies advantageously from 30 to 50, more advantageously from 38 to 45. The dry matter content of the initial aqueous composition varies advantageously from 35% to 60%, more advantageously from 35% to 50%, even more advantageously from 38% to 45%.

The rehydrated aqueous composition is stable, at least as stable as the original aqueous composition, if not more stable.

The rehydrated aqueous composition is suitable for protecting metal parts from corrosion.

According to an advantageous variant, a thickening agent is added to the rehydrated aqueous coating composition. The thickening agent is advantageously selected from the group consisting of cellulose derivatives such as hydroxymethylcellulose, hydroxyethylcellulose, hydroxypropylcellulose, cellulose acetobutyrate, xanthan gum, cellulose micro or nano fibrils, associative thickeners of the polyurethane or acrylic type, silicas, silicates such as magnesium and/or lithium silicates, optionally treated, or organophilic clays and mixtures thereof. The content of thickening agent is advantageously less than 7% by weight based on the total weight of the composition, advantageously between 0.005 and 7% by weight based on the total weight of the composition.

This rehydrated aqueous composition is particularly suitable for the preparation of an anti-corrosion coating for metal parts. The coating is obtained by applying the coating composition according to the invention to a substrate, in particular a metallic substrate, advantageously by spraying, dip-draining or dip-centrifuging, the coating layer then being subjected to a baking operation conducted preferably at a temperature of between 120° C. and 350° C., for about 10 to 60 minutes, by supplying thermal energy, such as by convection or infrared, or for about 30 seconds to 5 minutes by induction.

In particular, the anti-corrosion coating will result from an application operation involving, prior to a baking operation, an operation of drying the coated parts, advantageously metallic, by the supply of thermal energy, such as by convection, infrared or induction, at a temperature of between 30 and 250° C., advantageously of the order of 70° C., in convection or infrared for 10 to 30 minutes on line or for about 30 seconds to 5 minutes by induction. Prior to coating, it is advisable in most cases to remove foreign matter from the substrate surface, particularly by careful cleaning and degreasing. Under these conditions, the thickness of the dry coating film thus applied is advantageously between 3 μm (11 g/m²) and 30 μm (110 g/m²) and preferably between 4 μm (15 g/m²) and 12 μm (45 g/m²), more particularly between 5 μm (18 g/m²) and 10 μm (40 g/m²).

The substrate is advantageously metallic, preferably steel or steel coated with zinc or a zinc-based layer deposited by various application methods including mechanical deposition, to cast iron and aluminum.

The metallic substrate can be pre-treated, for example by chromate or phosphate treatment. Thus, the substrate can be pre-treated to have, for example, an iron phosphate coating in an amount of 0.1 to 1 g/m² or a zinc phosphate coating in an amount of 1.5 to 4 g/m².

### EXAMPLES

The following examples show ways in which the present invention may be implemented, but do not in any way limit the present invention.

Gas Phase Chromatography (GPC)

The analysis conditions are as follows:

Eluent=water−Flow rate=0.8 mL/min−Dilution=1 qs 60−Injection=100 μL−Detector: Refractive Index at 35° C.−TSK Gel type columns thermostatted at 40° C.: 1 pre-column+2 columns G2500PWXL+1 column G3000 PWXL+1 column G4000 PWXL.

Viscosity

Measurement of a flow time with a DIN 4 or AFNOR 4 type consistometric cup.

Preparation of the Test Panels:

Unless otherwise specified, test panels are typically cold rolled, low carbon steel panels. They may be prepared first by immersion in a cleaning solution. The panels may then be scrubbed with a cleaning pad, rinsed with water and then immersed again in the cleaning solution. After removing the solution, the panels are rinsed with tap water and dried.

Preparation of the Test Screws:

The screws are degreased in an alkaline medium at 80° C., then rinsed with water and dried before being shot-blasted.

Application of the Coating to the Test Parts and Weight of the Coating:

Clean parts are typically coated by dipping them into the coating composition, removing and draining excess composition from it, sometimes with a moderate stirring action, and then they are baked at a temperature corresponding to the technology that has been rehydrated. The coating weights (g/m²) are determined by comparative weighing before and after coating.

Corrosion Resistance Test—Hours of Salt Spray Resistance:

Salt spray tests are conducted according to ISO9227 (May 2012).

A score of 10 corresponds to 0 traces of red rust on the part.

### Comparative Example 1: Dehydration by Freeze-Drying or Vacuum Evaporation of a Coating Composition Based on a Sol/Gel Binder Matrix Obtained from Precursors Based Solely on Si

Dehydration:

Freeze-Drying

1 liter of a composition CC1, distributed in 4 round-bottom flasks, was freeze-dried, after prior freezing in liquid nitrogen. The freeze-drying operation, carried out at −80° C. and at a pressure of between 0.1 mbar and 0.26 mbar, took 24 h to obtain a dehydrated solid. The composition was subjected to distillation prior to freeze-drying to remove by evaporation the residual ethanol and water/ethanol azeotrope from the monomer reactions, and water was then added to obtain the same amount of final dry matter.

The resulting powder was stored for 2 weeks at room temperature and atmospheric pressure.

Vacuum Evaporation

280 g of a composition CC1 was evaporated for 5 h under vacuum (20 mbar) at a water bath temperature of 40° C. to obtain a solid that could be finely ground.

The composition was subjected to distillation prior to vacuum evaporation to remove by evaporation the residual ethanol and water/ethanol azeotrope resulting from the monomer reactions, and water was then added to obtain the same amount of final dry matter.

The resulting powder was stored for 1 day at room temperature and atmospheric pressure.

In both processes, the composition CC1 is prepared from the compounds according to the data in the following table (% by mass introduced*relative to the initial total weight):

TABLE 1

| | CC1 |
|---|---|
| Zn¹ | 27.3 |
| Al² | 6.4 |
| Glycidoxypropyltriethoxysilane | 8 |
| Tetraethyl orthosilicate | 2 |
| Dipropylene glycol | 10 |
| Water | 37.6 |
| Additives | 8.7 |

¹Zinc paste at about 92% in white spirit
²Alu Chromal VIII powder marketed by Eckart Werke (Al dry matter: 80% by weight)
*The levels given in Table 1 are the levels initially introduced into the mixture. Indeed, some of the constituents introduced can or will react with each other, at least partially, during the various stages of manufacture of the composition, or during subsequent baking, thus modifying the composition as it is prepared at the outset. This also applies to Tables 2 and 5.

Rehydration:

Rehydration tests of the powder from composition CC1, obtained after freeze-drying or vacuum evaporation, were attempted without success. In both cases, the Si binder-based composition powder obtained is not rehydratable.

### Example 1: Dehydration by Freeze-Drying or Vacuum Evaporation of a Coating Composition Based on a Sol/Gel Binder Matrix Obtained from Si and Ti Based Precursors

Dehydration:

Freeze-Drying

1 liter of a composition CI1, distributed in 4 round-bottom flasks, was freeze-dried after prior freezing in liquid nitrogen. The freeze-drying operation, carried out at −80° C. and at a pressure of between 0.1 mbar and 0.26 mbar, took 24 h to obtain a dehydrated solid which was subsequently ground into a fine powder with a particle size ranging from about 2 μm to a few mm.

The composition was subjected to distillation prior to freeze-drying to remove by evaporation the residual ethanol and water/ethanol azeotrope from the monomer reactions, and water was then added to obtain the same amount of final dry matter.

The resulting powder was stored for 2 to 3 weeks at room temperature and atmospheric pressure.

Vacuum Evaporation

350 g of a composition CI1 was evaporated for 7.5 h under vacuum (20 mbar) at a water bath temperature of 40° C. in order to obtain a solid that could be finely ground.

The composition was subjected to distillation prior to vacuum evaporation to remove by evaporation the residual ethanol and water/ethanol azeotrope resulting from the monomer reactions, and water was then added to obtain the same amount of final dry matter.

The resulting powder was stored for 1 day at room temperature and atmospheric pressure.

The composition of the composition CI1 is prepared from the compounds according to the data in the following table (% by mass introduced in relation to the initial total weight):

TABLE 2

| | CI1 |
|---|---|
| Zn¹ | 23.7 |
| Al² | 1.6 |
| Glycidoxypropyltriethoxysilane | 13.8 |
| Tetraethyl orthosilicate | 0.7 |
| Tetra ethoxytitanate | 4.4 |
| Dipropylene glycol | 5.5 |
| Water | 43.1 |
| Additives | 7.2 |

¹Dry zinc
²Alu Chromal VIII powder marketed by Eckart Werke
In CI1, the Ti/Si molar ratio is 27/73.

Rehydration:

The powder from composition CI1, whether obtained by freeze-drying or by vacuum evaporation, was then easily rehydrated at a stirring speed of about 300-500 rpm, by adding demineralized water, so as to obtain a liquid with the same dry matter by weight as the original liquid composition (dry matter content=41-42%). The composition thus obtained is referred to as:
CI′1 when the powder is obtained by freeze-drying
CI″1 when the powder is obtained by vacuum evaporation.

The stability of CI1/CI′1/CI″1 compositions after thickening by adding a cellulosic thickener, under stirring, once the composition is completely rehydrated, and after one month of storage at 20° C. is equivalent, as shown in the following table:

TABLE 3

| | CI1 | CI′1 | CI″1 |
|---|---|---|---|
| Viscosity CA4 (dry) at about 30 days, 20° C. | 103 | 105 | 98 |
| pH, at about 30 days, 20° C. | 8.4 | 8.2 | 8.2 |

The salt spray performance obtained is equivalent, as shown in the following table:

TABLE 4

| | CI1 | CI′1 | CI″1 |
|---|---|---|---|
| Coating weight (g/m²) | 27.4 | 27.4 | 28.3 |
| Salt spray resistance (hours) at t = 0 | 1368 | 1176 | 1368 |
| Note 10 | | | |

### Example 2: Dehydration by Freeze-Drying or Vacuum Evaporation of a Sol/Gel Matrix Coating Composition Obtained from Si and Ti Precursors, Enriched with Ti

Dehydration:

Freeze-Drying

1 liter of a composition CI2, distributed in 4 round-bottom flasks, was freeze-dried after prior freezing in liquid nitrogen. The freeze-drying operation, carried out at −80° C. and at a pressure of between 0.1 mbar and 0.26 mbar, took 24 h to obtain a dehydrated solid which was subsequently ground into a fine powder with a particle size ranging from about 2 μm to a few mm.

The composition was subjected to distillation prior to freeze-drying to remove by evaporation the residual ethanol and water/ethanol azeotrope from the monomer reactions, and water was then added to obtain the same amount of final dry matter.

The resulting powder was stored for about 3 weeks at room temperature and atmospheric pressure.

Vacuum Evaporation

1038 g of a composition CI2 was evaporated for 2.5 h under vacuum (20 mbar) at a water bath temperature of 40° C. to obtain a solid that could be finely ground.

The composition was subjected to distillation prior to vacuum evaporation to remove by evaporation the residual ethanol and water/ethanol azeotrope resulting from the monomer reactions, and water was then added to obtain the same amount of final dry matter.

The resulting powder was stored for 2 weeks at room temperature and atmospheric pressure.

The base compounds of the composition CI2 are given in the following table (% by mass introduced in relation to the initial total weight):

TABLE 5

| | CI2 |
|---|---|
| Zn¹ | 27.8 |
| Al² | 3.6 |
| Glycidoxypropyltriethoxysilane | 7.2 |
| Tetra-isopropoxytitanate | 7.2 |
| Water | 48.5 |
| Additives | 5.7 |

¹Dry zinc
²Alu Silbercote AQ E 2169 F3X

In CI2, the Ti/Si molar ratio is 50/50. After freeze-drying, the dry matter content is 96.8%.

Rehydration:

The powder from the composition CI2, whether obtained by freeze-drying or vacuum evaporation, was then easily rehydrated at a stirring speed of about 300 to 500 rpm by adding demineralized water, so as to obtain a liquid with the same dry matter by weight as the original liquid composition.

### Example 3: Spray Dehydration of a Coating Composition Based on a Sol/Gel Binder Matrix Obtained from Si and Ti Based Precursors

Dehydration:

Approximately 2.2 kg of the composition CI3 diluted to 35% dry matter was spray dehydrated. The spray parameters were adjusted to obtain a dry powder with a temperature below 40° C.

The resulting powder was stored for 2 weeks at room temperature and atmospheric pressure.

The base compounds of the composition CI3 are given in the following table (% by mass introduced in relation to the initial total weight):

TABLE 6

| | CI3 |
|---|---|
| Zn¹ | 23.7 |
| Al² | 1.6 |
| Glycidoxypropyltriethoxysilane | 13.8 |
| Tetraethyl orthosilicate | 0.7 |
| Tetra ethoxytitanate | 4.4 |
| Dipropylene glycol | 2.5 |
| Water | 46.1 |
| Additives | 7.2 |

¹Dry zinc
²Alu Silbercote AQ E 2169 F3X
In CI3, the Ti/Si molar ratio is 27/73. After spray drying, the dry matter content is 90.3%.

Rehydration:

The powder from the composition CI3 was easily rehydrated (<24 h) at a stirring speed of about 300 to 500 rpm, by adding demineralized water so as to obtain a liquid with the same dry matter by weight as the starting liquid composition (dry matter content=41-42%). The composition thus obtained is called:
CI3′ when the powder is obtained by spray drying
The compositions CI3/CI3′ after thickening by adding a cellulosic thickener, under stirring, once the composition is completely rehydrated, have the same parameters, as shown in the following table:

TABLE 7

| | CI3 | CI3′ |
|---|---|---|
| Viscosity CA4 (dry) at about 30 days, 20° C. | 126 | 101 |
| pH, at about 30 days, 20° C. | 8.4 | 8.3 |

The salt spray resistance performances obtained on screws are at least equivalent, or even superior, as shown in the following table:

TABLE 8

| | CI3 | CI3′ |
|---|---|---|
| Coating weight (g/m²) at t = 0 | 26.1 | 27.7 |
| Salt spray resistance (hours) at t = 0 | 672 | 1296 |
| Note 10 | | |
| Coating weight (g/m²) | 25.3 | 23.8 |
| at t = 1 month 20° C. | | |
| Salt spray resistance (hours) at | 720 | 672 |
| t = 1 month 20° C. Note 10 | | |

### Example 4: Dehydration by Vacuum Evaporation of a Coating Composition Based on a Sol/Gel Binder Matrix Obtained from Si and Ti Based Precursors

Dehydration:

978 g of the composition CI4 of 60.7% dry matter was evaporated for 7 h 5 min under vacuum (20 mbar) at a water bath temperature of 40° C. to obtain a solid that could be finely ground.

The resulting powder was stored for 12 days at room temperature and atmospheric pressure.

The base compounds of the composition CI4 are given in the following table (% by mass introduced in relation to the initial total weight):

TABLE 9

| | CI4 |
|---|---|
| Zn¹ | 29.1 |
| Al² | 4.1 |
| Glycidoxypropyltrimethoxysilane | 18.3 |
| Tetraethyl orthosilicate | 1.4 |
| Tetra ethoxytitanate | 6 |
| Dipropylene glycol | 8 |
| Alcohols (ethanol + 3% isopropanol) | 5.2 |
| Water | 16.5 |
| Additives | 11.5 |

¹Dry zinc
²Alu Chromal VIII powder marketed by Eckart Werke
In the composition CI4 the Ti/Si ratio is 24/76.

Rehydration:

The powder from the composition CI4 was easily rehydrated (<10 h) at a stirring speed of about 300 to 500 rpm, by adding demineralized water so as to obtain a dry matter liquid by weight of 38.6%. The composition thus obtained is called:
CI4′ when the powder is obtained by vacuum evaporation

The stability of compositions CI4/CI4′ at a dry matter of 38%, after one month of storage at 20° C. is equivalent, as shown in the following table:

TABLE 10

| | | 60% CI4 diluted | |
|---|---|---|---|
| | CI4 | to 38% by adding | |
| | (DM = 60%) | demineralized water | CI4′ |
| Viscosity CA4 (dry) at | gel | 21 | 23 |
| about 30 days, 20° C. | | | |
| pH, at about 30 days, 20° C. | NA | 7.7 | 7.9 |

1. A solid composition intended for the preparation of an anti-corrosion coating composition for metal parts based on particulate metal in aqueous dispersion, wherein
the composition is solid,
the composition is water-rehydratable,
the composition is based on:
a particulate metal or a mixture of particulate metals,
a titanate precursor and/or a zirconate precursor and
a silane bearing at least one function hydrolyzable to a hydroxyl function, the composition has a Ti/Si molar ratio ranging from 10/90 to 60/40.

2. The solid composition of claim 1, wherein the Ti/Si molar ratio varies from 20/80 to 50/50.

3. The solid composition of claim 1, wherein the composition is in powdered form, with a particle size ranging from about 2 μm to about 3 mm.

4. The solid composition of claim 1, wherein the composition is in the form of a gel.

5. The solid composition of claim 1, wherein the titanate precursor is an organic titanate, and the zirconate precursor is an organic zirconate.

6. The solid composition of claim 1, wherein the silane additionally carries an epoxy function.

7. The solid composition of claim 6, wherein the silane is selected from
epoxy-functional di- or trimethoxysilane and epoxy-functional di- or triethoxysilane, as well as mixtures thereof.

8. The solid composition of claim 1, wherein the particulate metal content ranges from 20 to 70% by weight, based on the total weight of the solid composition.

9. The solid composition of claim 1, wherein the particulate metal is selected from zinc and aluminum and their alloys and mixtures thereof or alloys thereof with manganese, magnesium, or tin.

10. The solid composition of claim 1, further based on a silicate.

11. The solid composition of claim 1, obtained by dehydration of an aqueous composition comprising the particulate metal, the titanate and/or zirconate precursor, the silane, optionally said a silicate, and water.

12. (canceled)

13. (canceled)

14. (canceled)

15. A process for preparing a solid composition comprising:
a step of dehydrating an aqueous composition comprising:
a particulate metal or a mixture of particulate metals,
a titanate and/or zirconate precursor,
a silane bearing at least one function hydrolyzable to a hydroxyl function, the composition has a Ti/Si molar ratio ranging from 10/90 to 60/40,
optionally a silicate, and
water;
then,
recovering a composition
which is solid,
which is water-rehydratable,
which is based on the particulate metal or the mixture of particulate metals,
the titanate precursor and/or the zirconate precursor,
the silane bearing at least one function hydrolyzable to a hydroxyl function, the composition has a Ti/Si molar ratio ranging from 10/90 to 60/40, and optionally the silicate.

16. The process of claim 15, wherein dehydration is conducted by freeze-drying, zeodration, vacuum evaporation, or spray drying.

17. A process for preparing an aqueous composition comprising:
providing a composition which is solid and which is based on
a particulate metal or a mixture of particulate metals,
a titanate precursor and/or a zirconate precursor,
a silane bearing at least one function hydrolyzable to a hydroxyl function,
the composition has a Ti/Si molar ratio ranging from 10/90 to 60/40, and
optionally a silicate,
then,
hydrating the solid, composition.

18. The solid composition according to claim 1, wherein the Ti/Si molar ratio varies from 25/75 to 50/50.

19. The solid composition of claim 1, wherein the titanate precursor is selected from C₁-C₈ tetraalkyl titanates, and the zirconate precursor is selected from C₁-C₈ tetraalkyl zirconates.

20. The solid composition of claim 6, wherein the silane is selected from beta-(3,4-epoxycyclohexyl)ethyl-trimethoxysilane, 4-(trimethoxysilyl)butane-1,2-epoxide, gamma-glycidoxypropyltrimethoxysilane, gamma-glycidoxypropyltriethoxysilane, octyltriethoxysilane, phenyltriethoxysilane, methyltriethoxysilane, (2-diethylphosphatoethyl) triethoxy silane, vinyltriethoxysilane, 3-aminopropyltriethoxysilane, methyl methacrylate trimethoxysilane, methyl methacrylate triethoxysilane and mixtures thereof.

21. The process of claim 15, wherein of the aqueous composition comprises at least 15% by weight of water, based on the total weight of the aqueous composition.

22. The process of claim 15, wherein of the aqueous composition further comprises an organic solvent, an ionic liquid, or mixtures thereof.

23. The process of claim 22, wherein of the aqueous composition comprises from 0.5 to 15% by weight, of organic solvent, ionic solvent, or mixtures thereof, based on the total weight of the aqueous composition.
